(19) United States
(12) Patent Application Publication
(10) Pub. No.: US 2015/0086357 A1
(43) Pub. Date: Mar. 26, 2015

(54) WIND TURBINE AND METHOD FOR ADJUSTING YAW BIAS IN WIND TURBINE

(71) Applicant: General Electric Company, Schenectady, NY (US)

(72) Inventor: Peter Alan Gregg, Niskayuna, NY (US)

(73) Assignee: General Electric Company, Schenectady, NY (US)

(21) Appl. No.: 14/034,776

(22) Filed: Sep. 24, 2013

(51) Int. Cl. F03D 7/04; F03D 7/02; F03D 11/00

(52) U.S. Cl. CPC F03D 7/046; F03D 11/0091; F03D 7/0204
USPC 416/1; 416/9

(57) ABSTRACT

Wind turbines and method for adjusting yaw bias in wind turbines are provided. In one embodiment, a method includes defining an operational condition for the wind turbine, the operational condition including a turbine speed range, a pitch angle range, and a wind speed range. The method further includes operating the wind turbine within the operational condition, adjusting a yaw angle of the wind turbine during operation of the wind turbine, and measuring power output of the wind turbine during operation within the operational condition.

### FIELD OF THE INVENTION

The present disclosure relates generally to wind turbines, and more particularly to systems and methods adjusting yaw bias in wind turbines.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and a rotor including one or more rotor blades. The rotor blades capture kinetic energy from wind using known foil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

During operation, the direction of the wind which powers a wind turbine may change. The wind turbine may thus adjust, through for example a yaw adjustment about a longitudinal axis of the tower, to maintain alignment with the wind direction. In many wind turbines, however, a yaw bias exists, such that after yawing the wind turbine is slightly misaligned with the wind direction. Such bias can be caused by, for example, the location of the wind sensor (such as a wind vane or anemometer) behind the blades, because the turbulence from the blades can introduce inaccuracies into the wind sensor readings. Such bias can also be caused by, for example, variations in the hardware utilized to mount the wind sensor to the wind turbine. As a result of such yaw bias, the overall power captured by the wind turbine may be reduced.

Various attempts have been made to increase the accuracy if the wind sensors and reduce yaw bias. For example, some past efforts have involved the application of a single blanket yaw correction. This blanket correction has been applied for all operating conditions of the wind turbine. However, the amount of yaw bias can change based on changes in various operating conditions, thus resulting in such blanket correction efforts being inaccurate when the wind turbine is subjected to various operating conditions. Other efforts have involved attempts to correlate yaw bias with wind speed. However, the amount of yaw bias can vary for a particular wind speed based on changes in other operating conditions, thus also resulting in inaccurate yaw bias corrections.

Accordingly, improved systems and methods for adjusting yaw bias in wind turbines are desired. In particular, systems and methods which accurately adjust yaw bias for a variety of operating conditions would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a method for adjusting yaw bias in a wind turbine. The method includes defining an operational condition for the wind turbine, the operational condition including a turbine speed range, a pitch angle range, and a wind speed range. The method further includes operating the wind turbine within the operational condition, adjusting a yaw angle of the wind turbine during operation of the wind turbine, and measuring power output of the wind turbine during operation within the operational condition.

In another embodiment, the present disclosure is directed to a method for adjusting yaw bias in a wind turbine. The method includes defining an operational condition for the wind turbine, the operational condition including a wind speed range and a range for at least one other operational parameter. The method further includes operating the wind turbine within the operational condition, adjusting a yaw angle of the wind turbine during operation of the wind turbine, and measuring power output of the wind turbine during operation within the operational condition.

In another embodiment, the present disclosure is directed to a wind turbine. The wind turbine includes a tower, a nacelle mounted to the tower, a rotor coupled to the nacelle, the rotor comprising a hub and a plurality of rotor blades, and a generator coupled to the rotor. The wind turbine further includes a controller, the controller operational to adjust a yaw angle of the wind turbine during operation of the wind turbine and measure power output of the wind turbine during operation within an operational condition, the operational condition including a turbine speed range, a pitch angle range, and a wind speed range.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 illustrates a perspective, internal view of a nacelle of a wind turbine according to one embodiment of the present disclosure;

FIG. 3 illustrates a top view of a wind turbine according to one embodiment of the present disclosure;

FIG. 4 illustrates a plot of power output as a function of yaw angle for an operational condition according to one embodiment of the present disclosure; and

FIG. 5 is a flow chart of a method for adjusting yaw bias in a wind turbine according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

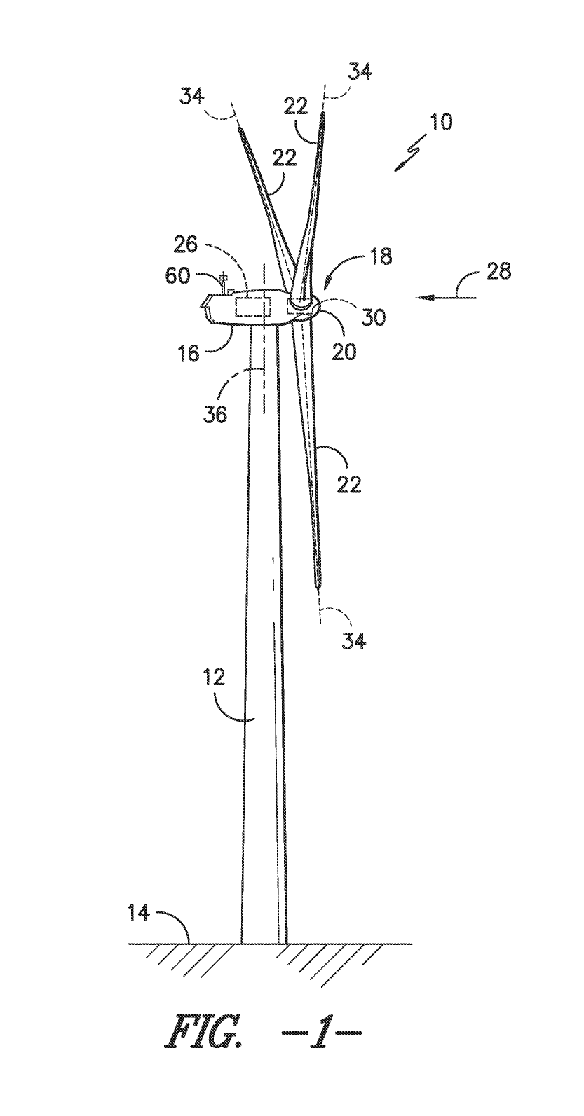

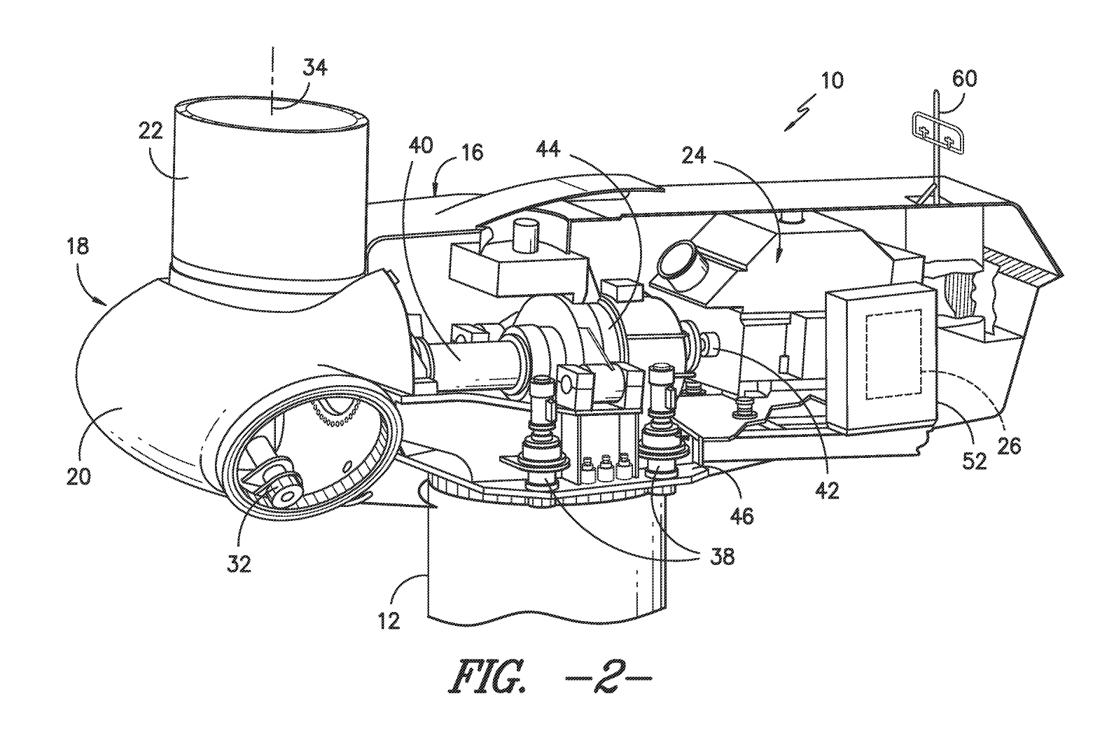

FIG. 1 illustrates perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a turbine control system or a turbine controller 26 centralized within the nacelle 16. However, it should be appreciated that the turbine controller 26 may be disposed at any location on or in the wind turbine 10, at any location on the support surface 14 or generally at any other location. The turbine controller 26 may generally be configured to control the various operating modes (e.g., start-up or shut-down sequences) and/or components of the wind turbine 10. For example, the controller 26 may be configured to control the blade pitch or pitch angle of each of the rotor blades 22 (i.e., an angle that determines a perspective of the rotor blades 22 with respect to the direction 28 of the wind) to control the loading on the rotor blades 22 by adjusting an angular position of at least one rotor blade 22 relative to the wind. For instance, the turbine controller 26 may control the pitch angle of the rotor blades 22, either individually or simultaneously, by transmitting suitable control signals/commands to a pitch controller of the wind turbine 10, which may be configured to control the operation of a plurality of pitch drives or pitch adjustment mechanisms 32 (FIG. 2) of the wind turbine, or by directly controlling the operation of the plurality of pitch drives or pitch adjustment mechanisms. Specifically, the rotor blades 22 may be rotatably mounted to the hub 20 by one or more pitch bearing(s) (not illustrated) such that the pitch angle may be adjusted by rotating the rotor blades 22 along their pitch axes 34 using the pitch adjustment mechanisms 32. Further, as the direction 28 of the wind changes, the turbine controller 26 may be configured to control a yaw direction of the nacelle 16 about a yaw axis 36 to position the rotor blades 22 with respect to the direction 28 of the wind, thereby controlling the loads acting on the wind turbine 10. For example, the turbine controller 26 may be configured to transmit control signals/commands to a yaw drive mechanism 38 (FIG. 2) of the wind turbine 10, via a yaw controller or direct transmission, such that the nacelle 16 may be rotated about the yaw axis 36.

It should be appreciated that the turbine controller 26 and/or the pitch controller 30 may generally comprise a computer or any other suitable processing unit. Thus, in several embodiments, the turbine controller 26 and/or pitch and yaw controllers may include one or more processor(s) and associated memory device(s) configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the turbine controller 26 and/or pitch and yaw controllers may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the turbine controller 26 and/or pitch and yaw controllers to perform various computer-implemented functions. In addition, the turbine controller 26 and/or pitch and yaw controllers may also include various input/output channels for receiving inputs from sensors and/or other measurement devices and for sending control signals to various components of the wind turbine 10.

Referring now to FIG. 2, a simplified, internal view of one embodiment of the nacelle 16 of the wind turbine 10 is illustrated. As shown, a generator 24 may be disposed within the nacelle 16. In general, the generator 24 may be coupled to the rotor 18 of the wind turbine 10 for generating electrical power from the rotational energy generated by the rotor 18. For example, the rotor 18 may include a main shaft 40 coupled to the hub 20 for rotation therewith. The generator 24 may then be coupled to the main shaft 40 such that rotation of the main shaft 40 drives the generator 24. For instance, in the illustrated embodiment, the generator 24 includes a generator shaft 42 rotatably coupled to the main shaft 40 through a gearbox 44. However, in other embodiments, it should be appreciated that the generator shaft 42 may be rotatably coupled directly to the main shaft 40. Alternatively, the generator 24 may be directly rotatably coupled to the main shaft 40 (often referred to as a “direct-drive wind turbine”).

It should be appreciated that the main shaft 40 may generally be supported within the nacelle by a support frame or bedplate 46 positioned atop the wind turbine tower 12. For example, the main shaft 40 may be supported by the bedplate 46 via a pair of pillow blocks 48, 50 mounted to the bedplate 46.

Additionally, as indicated above, the turbine controller 26 may also be located within the nacelle 16 of the wind turbine 10. For example, as shown in the illustrated embodiment, the turbine controller 26 is disposed within a control cabinet 52 mounted to a portion of the nacelle 16. However, in other embodiments, the turbine controller 26 may be disposed at any other suitable location on and/or within the wind turbine 10 or at any suitable location remote to the wind turbine 10. Moreover, as described above, the turbine controller 26 may also be communicatively coupled to various components of the wind turbine 10 for generally controlling the wind turbine and/or such components. For example, the turbine controller 26 may be communicatively coupled to the yaw drive mechanism(s) 38 of the wind turbine 10 for controlling and/or altering the yaw direction of the nacelle 16 relative to the direction 28 (FIG. 1) of the wind. Similarly, the turbine controller 26 may also be communicatively coupled to each pitch adjustment mechanism 32 of the wind turbine 10 (one of which is shown) through the pitch controller 30 for controlling and/or altering the pitch angle of the rotor blades 22 relative to the direction 28 of the wind. For instance, the turbine controller 26 may be configured to transmit a control signal/command to each pitch adjustment mechanism 32 such that one or more actuators (not shown) of the pitch adjustment mechanism 32 may be utilized to rotate the blades 22 relative to the hub 20.

As further shown in FIG. 2, a wind sensor 60 may be provided on the wind turbine 10. The wind sensor 60, which may for example be a wind vane, and anemometer, and LIDAR sensor, or another suitable sensor, may measure wind speed and direction. The wind sensor 60 may further be in communication with the controller 26, and may provide such speed and direction information to the controller 26. For example, yawing of the wind turbine 10 may occur due to sensing of changes in the wind direction 28, in order to maintain alignment of the wind turbine 10 with the wind direction 28.

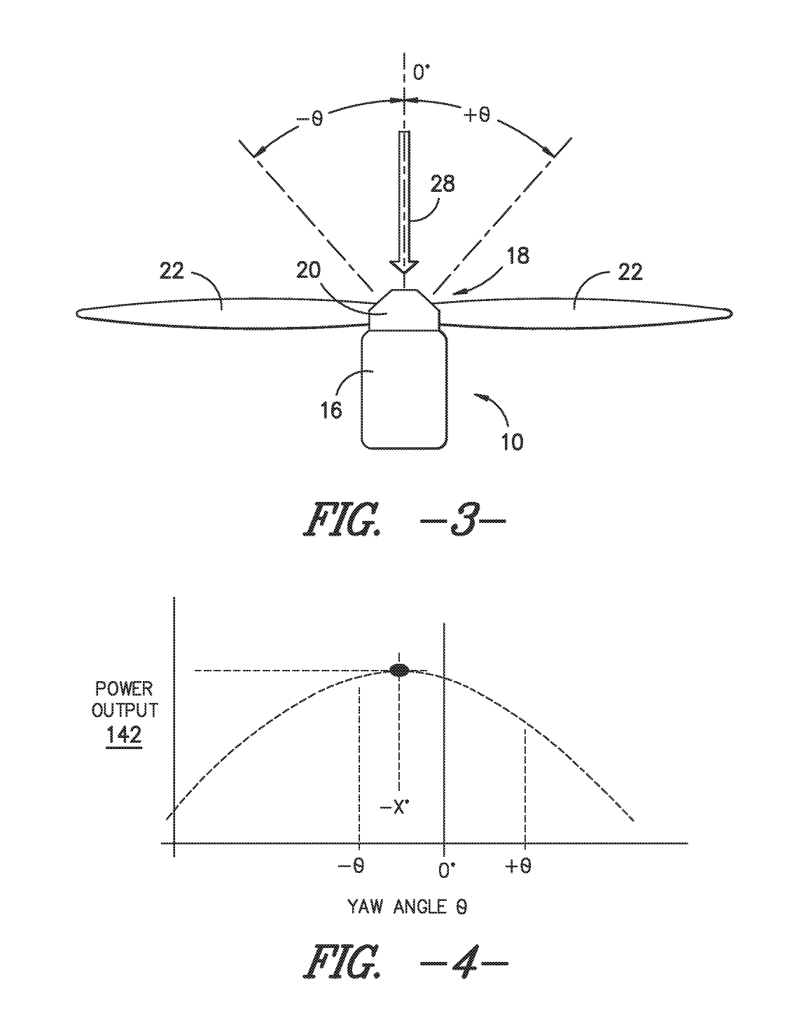

Referring now to FIG. 3, and as discussed above, a wind turbine 10, such as the nacelle 16 thereof, may rotate about the yaw axis 36 as required. Yaw axis may generally extend along (and be coaxial with) a longitudinal axis of the tower 12. In particular, rotation about the yaw axis 36 may occur due to changes in the wind direction 28, such that the rotor 18 is aligned with the wind direction 28. FIG. 3 illustrates a wind directions 28 which is aligned with the rotor 18, such that a central axis of the rotor 18 and/or a longitudinal axis of the nacelle 16 may for example be generally parallel with the wind direction 28.

In some cases, however, after rotation about the yaw axis 36, the rotor 18 may remain slightly misaligned with the wind direction 28, causing a yaw bias which, as discussed above, can reduce the power generated by the wind turbine. For example, misalignments relative to the wind direction 28 are illustrated. Such misalignment may be by any suitable angle, and either to the right or left of the wind direction 28 (in a top view as shown in FIG. 3). As shown, a negative θ indicates a yaw angle θ to the left of the wind direction 28, while a positive θ indicates a yaw angle θ to the right of the wind direction 28.

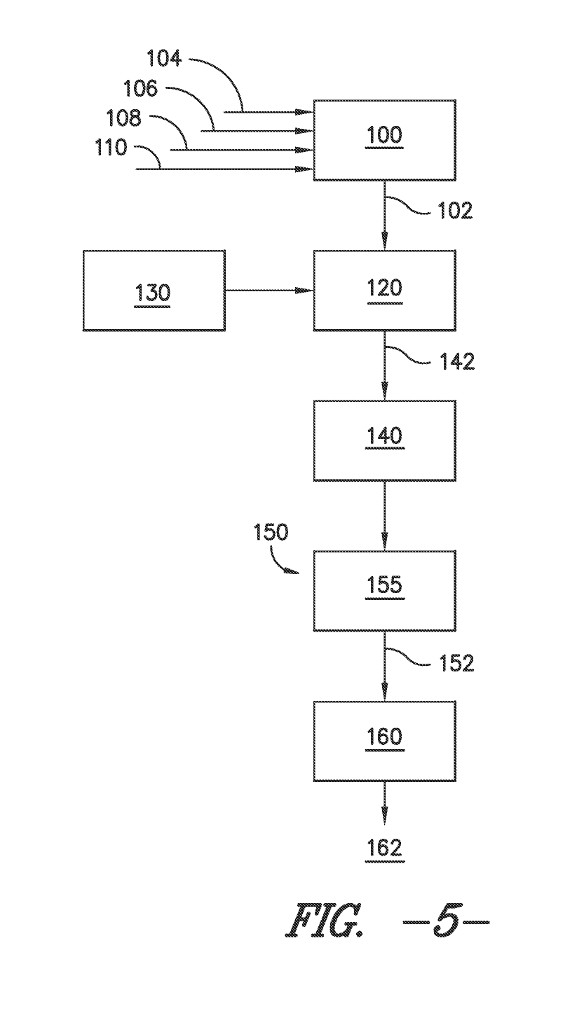

Referring now to FIGS. 4 and 5, the present disclosure is thus directed to methods for adjusting yaw bias in a wind turbine 10. Such adjustment may reduce the yaw bias, such that a wind turbine 10 can accurately align with the wind direction 28 and increase the power generated therefrom.

A method may include, for example, the step 100 of defining one or more operational conditions 102 for the wind turbine. Such operational conditions 102 may generally be predetermined, and are generally sets of ranges for various operational parameters of the wind turbine 10 during operation thereof. For example, in exemplary embodiments, an operational condition may include one or more operational parameters and ranges thereof, such as in exemplary embodiments turbine speed range, pitch angle range 104, and wind speed range 106. The turbine speed range 104 may be the rotor speed range 108 and/or the generator speed range 110. Other suitable operational parameters include, for example, power output and rotor position. In general, an operational condition 102 may include a wind speed range 106 and at least one other operational parameter and range thereof.

Various operational conditions 102 may be predetermined for a wind turbine 10, and each may include a predetermined range for each operational parameter thereof. For example, one operational condition 102 may be a run-up condition. In one run-up condition, for example, the generator speed may be between approximately 0.4 and approximately 0.7 times a rated generator speed for the wind turbine 10, the wind speed may be less than 5 meters per second, and the pitch angle range may be variable throughout the allowable range of pitch angles. Another operational condition 102 may be a wind turbine standstill condition. In one turbine standstill condition, for example, the generator speed may be less than approximately 0.07 times a rated generator speed for the wind turbine 10, the wind speed may be any suitable wind speed, and the pitch angle range may be a constant pitch angle. Other operational conditions may include an idle condition (for example, generator speed approximately 0.7 times a rated generator speed for the wind turbine 10, wind speed less than 5 meters per second, and pitch angle constant); lower constant speed load condition (for example, generator speed approximately 0.6 times a rated generator speed for the wind turbine 10, wind speed variable, pitch angle constant); variable speed condition (for example, generator speed between approximately 0.6 and approximately 1.05 times a rated generator speed for the wind turbine 10, wind speed variable, pitch angle constant); rated turbine speed condition (for example, generator speed approximately 1.05 times a rated generator speed for the wind turbine 10, wind speed variable, pitch angle constant, such that output power is greater than approximately 800 kilowatts); peak shaver condition (for example, generator speed less than approximately 1.05 times a rated generator speed for the wind turbine 10, wind speed variable, pitch angle variable, such that output power is greater than approximately 1200 kilowatts); rated power condition (for example, generator speed variable, wind speed variable, pitch angle variable, such that output power is greater than approximately 1600 kilowatts); and/or high wind speed condition (for example, generator speed variable, wind speed greater than 15 meters per second, pitch angle variable).

A method may further include, for example, the step 120 of operating the wind turbine 10 within the one or more operational conditions 102. Such operation may be a constant operation within an operational condition 102, followed if required by constant operation within another operational condition 102, or may be intermittent operation within various operational conditions 102 such that, during operation of the wind turbine 10, the wind turbine 10 is intermittently operated within an operational condition 102. For example, in some instances, the wind turbine 10 may be operated as in a normal operating scenario, with various operational conditions 102 being met during such operation. In other instances, the wind turbine 10 may be purposefully operated in, for example, a test scenario wherein operational conditions 102 are met.

A method may further include, for example, the step 130 of adjusting a yaw angle θ of the wind turbine 10 during operation within the operational condition 102. In general, it is desirable according to the present disclosure to adjust the yaw angle θ such that the wind turbine 10 is operated at a large range of yaw angles θ for a relatively constant wind direction 28. Thus, adjustments to the power output of the wind turbine 10 are facilitated during operation within the operational condition. In exemplary embodiments, the yaw angle θ may be adjusted through a full or partial range of yaw angles θ for the wind turbine 10 during operation within the operational condition and for a generally constant wind direction 28.

A method may further include, for example, the step 140 of measuring power output 142 of the wind turbine 10 during operation within the one or more operational conditions 102. Such measurements of power output 142 may be taken by suitable sensors and communicated to the controller 26. Further, such measurements 142 may, in the controller 26, be segmented per operational condition 102 such that a range of power outputs 142 as a function of yaw angle θ for each operational condition 102 is obtained. In exemplary embodiments, measuring of the power output 142 may occur for each operational condition 102 for a predetermined period of time, in order to obtain suitable power output 142 data as a function of yaw angle θ for an operational condition 102. This predetermined period of time may further occur before any implementation of yaw offset to reduce yaw bias, as discussed below.

A method may further include, for example, the step 150 of identifying a yaw error 152 for one or more of the operational conditions 102 based on the measured power output 142. The yaw error 152 (or yaw bias) is the difference between the desired direction of the wind turbine 10 with respect to a wind direction 28 and the actual direction of the wind turbine 10 with respect to that wind direction. In other words, the yaw error 152 is the yaw angle θ of the wind turbine 10 relative to a wind direction 28 for an operational condition 102.

In exemplary embodiments, the step of identifying the yaw error 152 includes the step 155 of plotting or otherwise associating the power output 142 as a function of the yaw angle θ within one or more operational conditions 102. For example, FIG. 4 illustrates one embodiment of a plot of the power output 142 versus the yaw angle θ for an operational condition 102. The yaw error 152 can be determined through such plotting or otherwise associating because it is generally the yaw angle θ at which the maximum power output 142 occurs for an operational condition 142. As shown, 0 degrees indicates no yaw relative to a wind direction 28 such that the wind turbine 10 is aligned with the wind turbine 10 for an operational condition 142. If the wind turbine 10 were actually aligned with the wind direction 28 when it is indicated that the wind turbine 10 is so aligned, the maximum power output 142 would be at such 0 degree alignment. An offset maximum power output 142 indicates a yaw bias, and thus a yaw error 152.

A method may further include, for example, the step 160 of implementing a yaw offset 162 for an associated operational condition 102 based on the yaw error 152. The yaw offset 162 may generally be a yaw angle opposite to the angle of the yaw error 152. For example, such implementing step 152 may include instructing the yaw drive mechanism 38 to, when yawing such that the wind turbine 10 is aligned with the wind direction 28, offset this yaw by the yaw offset 162.

It should be understood that the yaw error 152 and yaw offset 162 are angles that are relative to the alignment of the wind turbine 10 with the wind direction 28, as discussed above. Further, the yaw error 152 and yaw offset 162 may change for each operational condition 102, and may thus be implemented separately for each associated operational condition 102 as required.

It should further be understood that the various methods steps, including but not limited to steps 130, 140, 150 and 16 may be performed in exemplary embodiments by the controller 26. Thus, a wind turbine 10 according to the present disclosure may include a controller 26 that is operational to, for example, adjust a yaw angle θ of the wind turbine 10 during operation of the wind turbine 10 and measure power output 142 of the wind turbine 10 during operation within one or more operational conditions 102. The controller 26 may further be operational to, for example, identify a yaw error 152 for the operational condition(s) 102 based on the measured power output 142. Such identification may be performed by, for example, plotting the power output 142 as a function of the yaw angle θ within the operational condition 102. The controller 26 may further be operational to, for example, implement a yaw offset 162 for the operational condition(s) 102 based on the yaw error 152.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for adjusting yaw bias in a wind turbine, the method comprising:
defining an operational condition for the wind turbine, the operational condition comprising a turbine speed range, a pitch angle range, and a wind speed range;
operating the wind turbine within the operational condition;
adjusting a yaw angle of the wind turbine during operation of the wind turbine; and
measuring power output of the wind turbine during operation within the operational condition.

2. The method of claim 1, further comprising identifying a yaw error for the operational condition based on the measured power output.

3. The method of claim 2, further comprising implementing a yaw offset for the operational condition based on the yaw error.

4. The method of claim 3, wherein the measuring step occurs for a predetermined time period before the implementing step.

5. The method of claim 2, wherein the identifying step comprises plotting the power output as a function of the yaw angle within the operational condition.

6. The method of claim 1, wherein the operational condition is one of a run-up condition, an idle condition, a rated turbine speed condition, or a high wind speed condition.

7. The method of claim 1, wherein a plurality of operational conditions are defined.

8. The method of claim 1, wherein the turbine speed range is a rotor speed range.

9. The method of claim 1, wherein the turbine speed range is a generator speed range.

10. A method for adjusting yaw bias in a wind turbine, the method comprising:
defining an operational condition for the wind turbine, the operational condition comprising a wind speed range and a range for at least one other operational parameter;
operating the wind turbine within the operational condition;
adjusting a yaw angle of the wind turbine during operation of the wind turbine; and
measuring power output of the wind turbine during operation within the operational condition.

11. The method of claim 10, further comprising identifying a yaw error for the operational condition based on the measured power output.

12. The method of claim 11, further comprising implementing a yaw offset for the operational condition based on the yaw error.

13. The method of claim 12, wherein the measuring step occurs for a predetermined time period before the implementing step.

14. The method of claim 11, wherein the identifying step comprises plotting the power output as a function of the yaw angle within the operational condition.

15. The method of claim 10, wherein the operational condition is one of a run-up condition, an idle condition, a rated turbine speed condition, or a high wind speed condition.

16. A wind turbine, comprising:
a tower;
a nacelle mounted to the tower;
a rotor coupled to the nacelle, the rotor comprising a hub and a plurality of rotor blades;
a generator coupled to the rotor;
a controller, the controller operational to adjust a yaw angle of the wind turbine during operation of the wind turbine and measure power output of the wind turbine during operation within an operational condition, the operational condition comprising a turbine speed range, a pitch angle range, and a wind speed range.

17. The wind turbine of claim 16, wherein the controller is further operational to identify a yaw error for the operational condition based on the measured power output.

18. The wind turbine of claim 17, wherein the controller is further operational to implement a yaw offset for the operational condition based on the yaw error.

19. The wind turbine of claim 18, wherein the controller is operational to identify the yaw error by plotting the power output as a function of the yaw angle within the operational condition.

20. The wind turbine of claim 16, wherein the operational condition is one of a run-up condition, an idle condition, a rated turbine speed condition, or a high wind speed condition.
